(19) United States
(12) Patent Application Publication
(10) Pub. No.: US 2010/0274852 A1
(43) Pub. Date: Oct. 28, 2010

(54) Method and Apparatus for Sharing Context to One or More Users

(75) Inventors: Marko Anderson, Boston, MA (US); Marco Paglia, San Francisco, CA (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/431,740

(22) Filed: Apr. 28, 2009

(51) Int. Cl. G06F 3/01; G06F 15/16; G06F 3/048

(52) U.S. Cl. 709/204; 715/744; 715/810

(57) ABSTRACT

In accordance with an example embodiment of the present invention, an apparatus comprises at least one processor and at least one memory. The at least one memory includes computer program code. Further, the at least one memory and the computer program code configured to, with the at least one processor, cause the apparatus to perform at least the following receive content related to a first contact based at least in part on a configuration of a second contact. Further, the apparatus comprises a user interface configured to display the content.

### TECHNICAL FIELD

The present application relates generally to sharing content to one or more users.

### BACKGROUND

An electronic device may have a user interface to access contacts. Further, there may be different types of user interfaces. As such, the electronic device facilitates use of contacts for different types of user interfaces.

### SUMMARY

Various aspects of examples of the invention are set out in the claims.

According to a first aspect of the present invention, an apparatus comprises at least one processor and at least one memory. The at least one memory includes computer program code. Further, the at least one memory and the computer program code configured to, with the at least one processor, cause the apparatus to perform at least the following receive content related to a first contact based at least in part on a configuration of a second contact. Further, the apparatus comprises a user interface configured to display the content.

According to a second aspect of the present invention, a method comprises receiving content related to a first contact based at least in part on a configuration of a second contact and displaying the content.

According to a third aspect of the present invention, an apparatus comprises at least one processor and at least one memory. The at least one memory includes computer program code. Further, the at least one memory and the computer program code configured to, with the at least one processor, cause the apparatus to perform at least the following: send content related to a first contact and allow configuration of the first contact based at least in part on a configuration of a second contact.

According to a fourth aspect of the present invention, a method comprises sending content related to a first contact and allowing configuration of the first contact based at least in part on a configuration of a second contact.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram depicting a network for synchronizing contacts in accordance with an example embodiment of the invention;

FIG. 3 is a block diagram depicting a computer operating in accordance with an example embodiment of the invention;

FIG. 4 is a flow diagram illustrating an example method to send an invitation in accordance with an example embodiment of the invention;

FIG. 5 is a block diagram depicting an electronic device operating in accordance with an example embodiment of the invention;

FIG. 6 is a flow diagram illustrating an example method to receive an invitation in accordance with an example embodiment of the invention;

FIG. 7A is a screen view depicting a computer operating in accordance with an example embodiment;

FIG. 7B is a screen view depicting an electronic device operating in accordance with an example embodiment;

FIG. 7C is a screen view depicting a configuration view on an electronic device operating in accordance with an example embodiment;

FIG. 8 is a screen view depicting a drag and drop feature on a computer operating in accordance with an example embodiment; and

FIG. 9 is a screen view depicting another configuration view on a computer operating in accordance with an example embodiment.

### DETAILED DESCRIPTION OF THE DRAWINGS

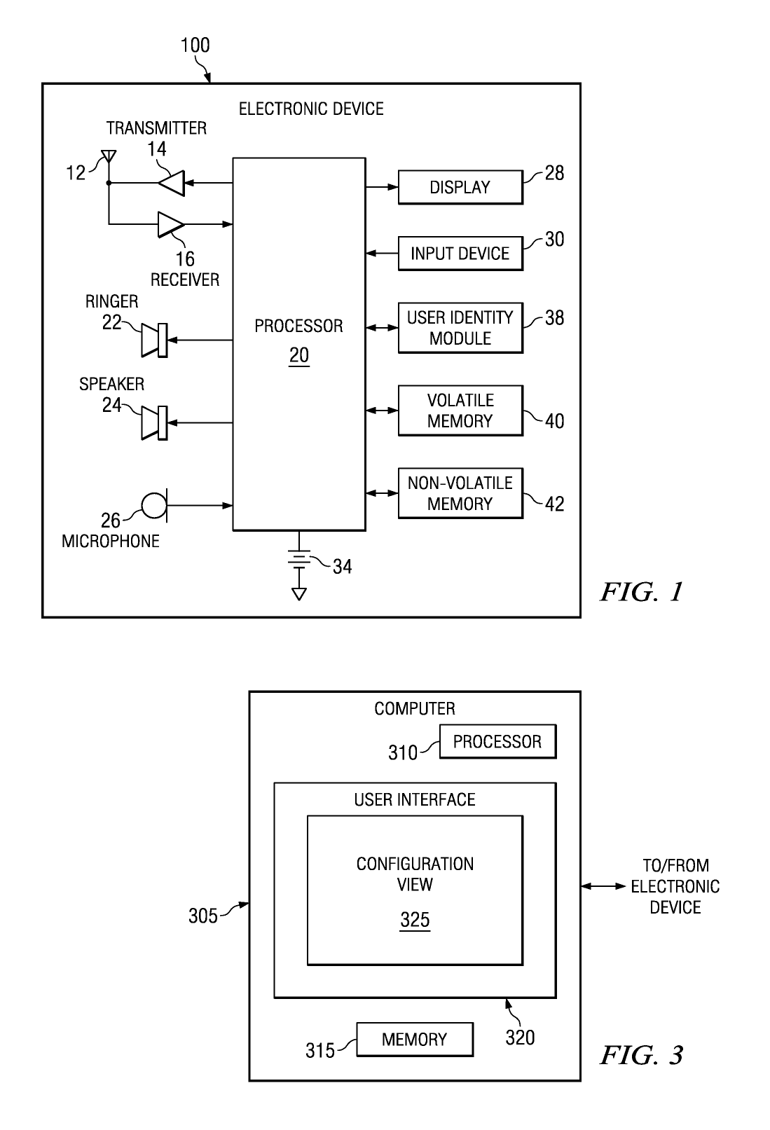

An example embodiment of the present invention and its potential advantages are understood by referring to FIGS. 1 through 9 of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. In an example embodiment, the electronic device 100 may comprises multiple processors, such as processor 20. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, an input device 30 comprises a mouse, a touch screen interface, a pointer, and/or the like. In an embodiment, the one or more output devices of the user interface may be coupled to the processor 20. In an example embodiment, the display 28 is a touch screen, a liquid crystal display, an electronic ink, and/or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

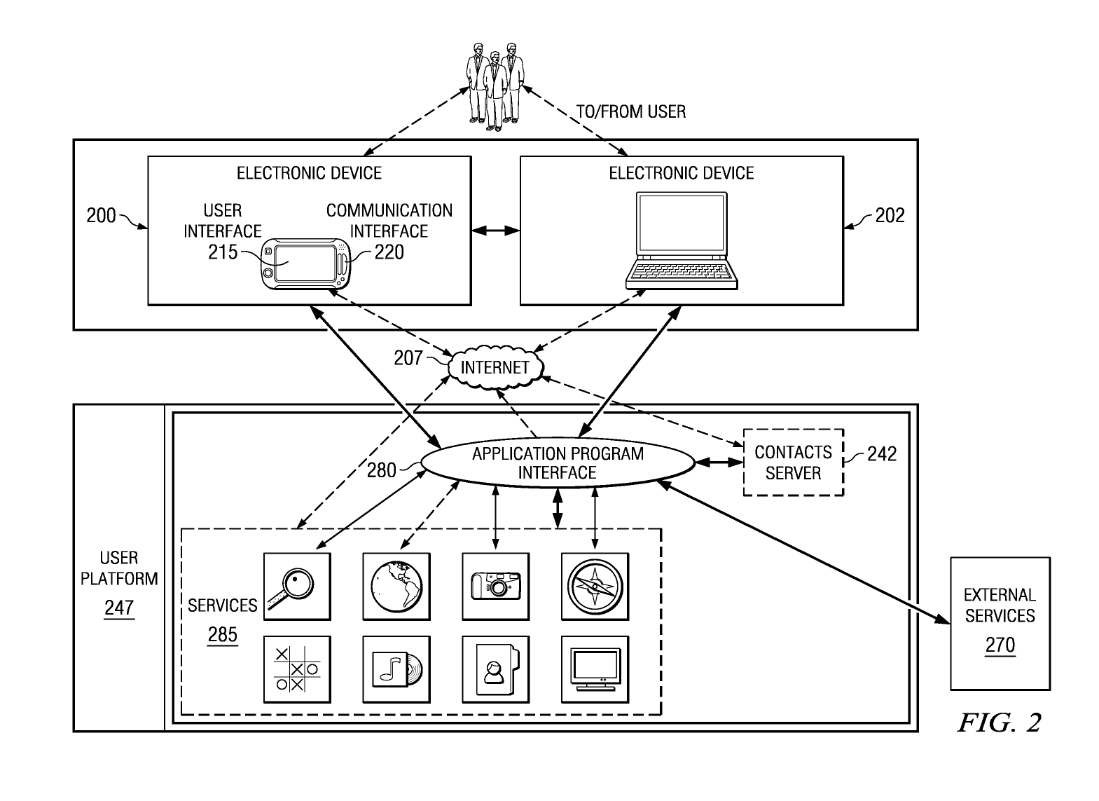

FIG. 2 is a block diagram depicting a network for synchronizing contacts in accordance with an example embodiment of the invention. In an example embodiment, electronic devices 200, 202 may be in communication with a user platform 247, via a network, for example Internet 207. Further, the electronic devices 200, 202 may comprise a user interface, such as user interface 215, a communication interface 220, and/or a processor.

In an example embodiment, at least one processor, such as processor 20 of FIG. 1, may be configured to execute instructions stored in a memory device of the electronic device 200, such as memory devices 40, 42 of FIG. 1. In an embodiment, the processor may be a microprocessor, various other processing elements, such as an integrated circuit, and/or the like. For example, the processor may be an application specific integrated circuit (ASIC), a field programmable gate array (FPGA), and/or the like.

In an embodiment, the memory device may be configured to buffer input data for processing by the processor. In an alternative embodiment, the memory device may be configured to store instructions for execution by the processor. In another alternative embodiment, the memory device may be one of a plurality of databases. Further, the memory device may store at least one contact in real time or otherwise dynamic manner. In an embodiment, the at least one contact may comprise one or more of the following information: a mobile number, a name, a short message service contact, a multimedia messaging service contact, an email address, a chat identifier, a location, an Internet protocol address, a voice over Internet protocol client, user profile information, one or more shared files, e.g., documents, photos, media content, and/or the like, or combination thereof, and/or the like. In an embodiment, a widget may be an element of a graphical user interface (GUI). Further, the widget may comprise contact information.

In an example embodiment, user platform 247 may be in communication with electronic devices 200, 202. In an example embodiment, the user platform 247 may comprise one or more services 285, a contacts server 242, and/or an application program interface (API) 280. For example, the contacts server 242 may store one or more contacts. In an embodiment, the contacts server 242 may be a web server, database server, file server, and/or the like. Further, the contacts server 242 may comprise a memory device, a processor, and/or a communication interface for communicating over the Internet 207 to, for example communication interface 220 of the electronic device 200.

In an embodiment, the electronic device 200 may use the communication interface 220 to communicate with the contacts server 242, a user platform 247, and/or external services 270 via a network, such as Internet 207. For example, the communication interface 220 may be configured to receive at least one updated contact from a server, such as user platform 247, service 285, external services 270, and/or the like. Further, the communication interface 220 may transfer the at least one updated contact to electronic device 200 and/or electronic device 202 for synchronization. For example, the communication interface 200 transfers updated contact information for an organization. In an alternative embodiment, the electronic device 200 may communicate or receive the updated contact, via the API 280, to the contacts server 242, services 285, external services 270, and/or the like via the Internet 207.

In an embodiment, at least one contact may be synchronized between one of the electronic device 200, 202 and the user platform 247 in real time. For example, the contacts server 242 may be configured to synchronize the at least one contact when a contact has been changed. Further, the contacts server 242 may be configured to update the at least one contact in real time. For example, if one contact has changed on the contacts server 242, the electronic device 200 may synchronize the at least one contact between the contacts server 242 and the electronic device 200 in real time, e.g., as the update occurs.

In another embodiment, the services 285 may be configured to synchronize the at least one contact when a contact has been changed. Further, the services 285 may be configured to update the at least one contact in real time. For example, if one contact has changed on the contacts server 242, the electronic device 200, or services 285 may synchronize the at least one contact between the contacts server 242, services 285, and/or the electronic device 200 in real time. In this way, the electronic device 200, contacts server 242, and/or services 285 maintain substantially the same contacts in real time.

In an embodiment, the user platform 247 may be used to facilitate storing, retrieving, computing, transmitting, receiving, and/or the like, at least one contact. Further, the user platform 247 may be embodied as an electronic device, such as the electronic device 100 of FIG. 1, the electronic device 200, the electronic device 202, and/or the like. The user platform 247 may also be configured to communicate with one or more users using the contacts. For example, the user platform 247 may be configured to allow a user of electronic device 200 to contact a second user via a communication, messaging system, communications protocol, and/or the like, e.g., emails, multimedia messaging service (MMS), short message service (SMS) messages, phone calls, and/or the like, using contact information in the contact. It should be understood that MMS may be a messaging system, which may allow a user to send messages comprising multimedia objects, e.g., images, audio, video, rich text. Further, a SMS may be a communications protocol to allow the interchange of short text messages between electronic devices.

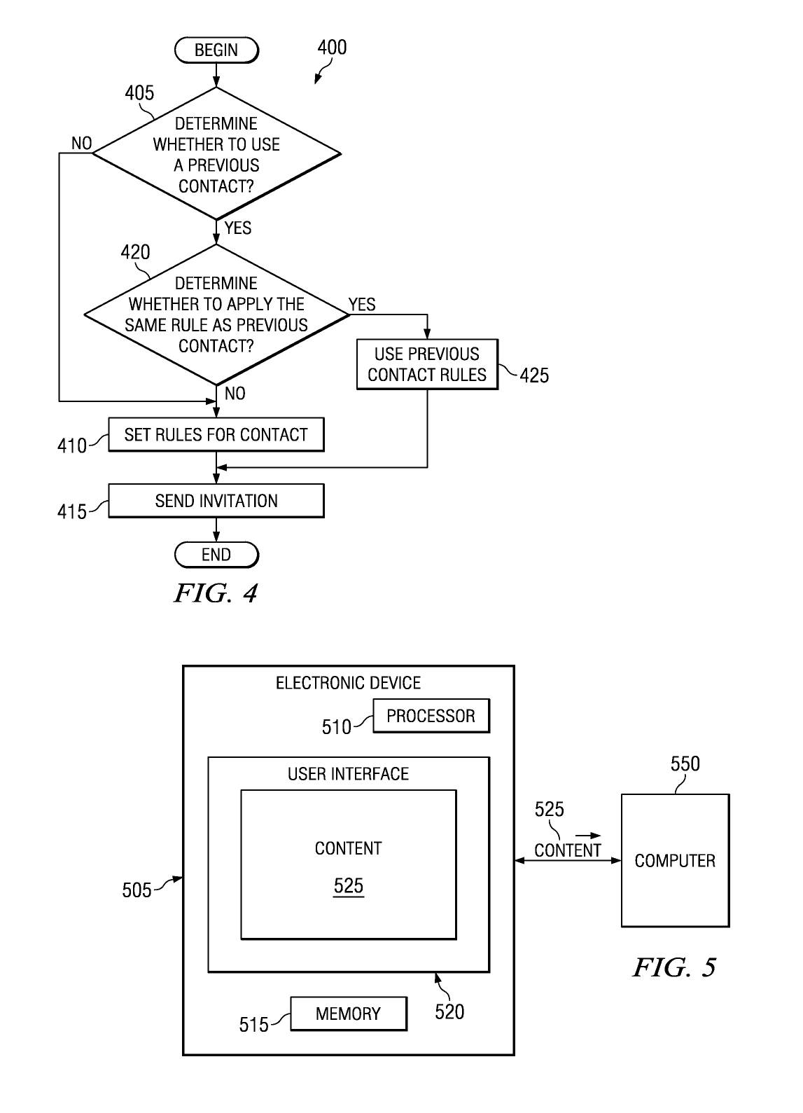

FIG. 3 is a block diagram depicting a computer 305 operating in accordance with an example embodiment of the invention. In an example embodiment, the computer 305 comprises at least one processor 310, at least one memory 315 and/or a user interface 320. Further, the computer 305 may be in communication with an electronic device. In an embodiment, the processor 310 comprises at least one memory 315. The at least one memory 315 may comprise computer program code. In an example embodiment, the at least one memory 315 comprises computer program code. In an embodiment, the computer program code is configured to, with the at least one processor, cause the computer 305 to perform at least the following display content related to a first contact and/or allow configuration of the first contact based at least in part on a configuration of a second contact. In an alternative embodiment, the at least one memory 315 may be separate from the processor 310.

In an example embodiment, the content is at least one of the following: a mobile number, a name, a short message service contact, a multimedia messaging service contact, an email address, a chat identifier, a location, an Internet protocol address, an Inter service provider, a voice over Internet protocol client, user profile information, one or more shared files, or combination thereof. In an embodiment, the user interface 320 is configured to display a configuration view 325. The configuration view 325 may be used to share content to one or more contacts. In an embodiment, the processor 310 is further configured to share content with a second contact, where the shared content is the same as a first contact. For example, the pictures, which are related to a soccer game, are shared between two users. In an alternative embodiment, the processor is configured to share content with a third contact where the shared content is different than the shared content of the second contact. For example, pictures from the first contact, which are different than, for example, the soccer game pictures shared with the third contact. A technical effect of one or more of the example embodiments disclosed herein is sharing different content based at least in part on the contact.

In an example embodiment, the processor 310 is further configured to send an invitation to the second contact. For example, the processor 310 sends an invitation to a user of an electronic device to share content. In an embodiment, the processor 310 may be configured to receive an invitation acceptance from the second contact. For example, the processor 310 receives a confirmation to share content with the second contact.

In an example embodiment, the processor 310 is further configured to receive a privacy configuration from the second contact. For example, the processor 310 receives a request to not share the second contact's information. In an example embodiment, the processor 310 is further configured to receive an invitation acceptance and set a privacy configuration concurrently. For example, the processor 310 receives an invitation to receive shared content, but not to include the contact's user information. In an example embodiment, the processor 310 is further configured to send an update of what content to share with the second contact. For example, the processor sends a list of content information to be shared.

In an example embodiment, the user interface 320 is further configured to display a content sharing menu with the second contact. For example, a user views the content sharing menu on a display. In an embodiment, the content sharing menu may be used to update the content sharing.

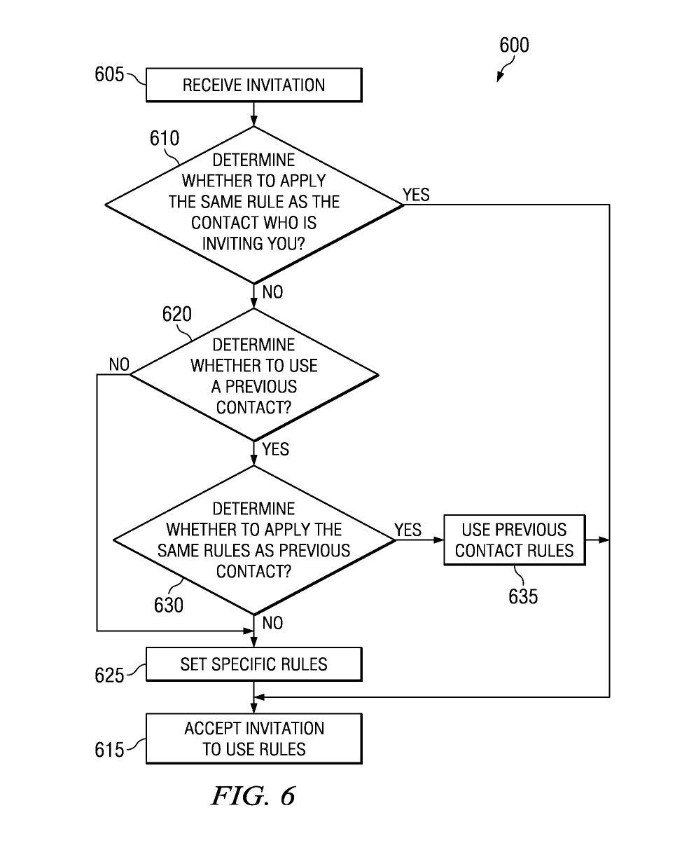

FIG. 4 is a flow diagram illustrating an example method 400 to send an invitation in accordance with an example embodiment of the invention. Example method 400 may be performed by a computer, such as computer 305 of FIG. 3.

At 405, it is determined whether to use a previous contact for sharing. In an example embodiment, a user interface, such as user interface 320 of FIG. 3, of the computer displays of a configuration view displaying each of the shared contents. For example, the configuration view depicts each of the available sharing content configurations.

If at 405 it is determined to use a previous contact for sharing, then at 420 it is determined whether to apply the same rule as the previous contact. In an example embodiment, a processor of the computer, such as processor 310 of FIG. 3 is configured to allow section of a rule relating to a share configuration. For example, the processor allows a user to select a rule for a contact to associate with another contact.

If at 420 it is determined to apply the same rule as the previous contact, then at 425 the previous contact rule is used. In an example embodiment, the processor is configured to receive an acceptance of the previous rule. For example, the user accepts the rule and the processor receives the acceptance.

At 415, the invitation is sent. In an example embodiment, the processor is configured to send an invitation to another contact. For example, the processor sends an invitation to a contact using an electronic device. The example method 400 ends.

If at 420 it is determined not to apply the same rule as the previous contact, then the example method 400 returns to 410. At 410, rules for the contact are set. In an example embodiment, the user interface is configured to allow a user to select the rules. For example, the user selects the contact to be associated with another contact. The example method 400 continues at 415.

If at 405 is determined not to use a previous contact for sharing, then the example method 400 continues at 410.

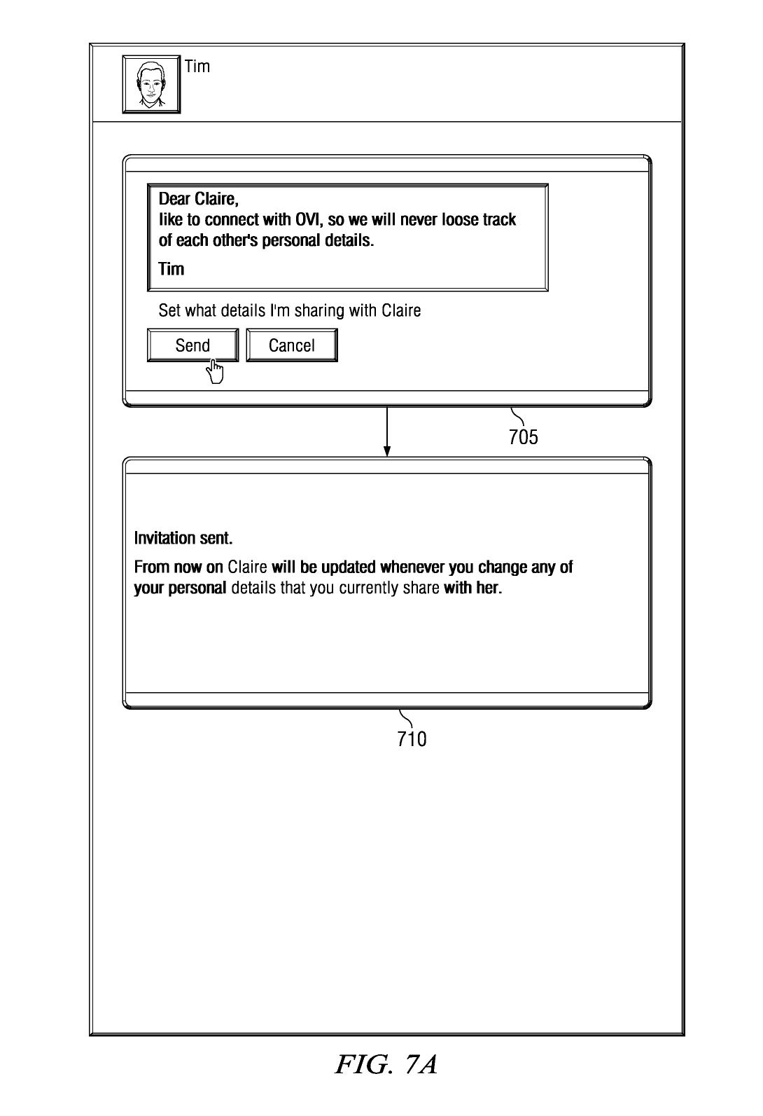

FIG. 5 is a block diagram depicting an electronic device 505 operating in accordance with an example embodiment of the invention. In an example embodiment, the electronic device 505 comprises at least one processor 510, at least one memory 515 and/or a user interface 520. In an example embodiment, the electronic device 505 may be in communication with a computer 550. In an example embodiment, computer 550 is similar to computer 305 of FIG. 3. In an alternative embodiment, computer 550 is different than computer 305 of FIG. 3.

In an example embodiment, the memory 515 comprises computer program code. In an embodiment, the computer program code is configured to, with the at least one processor, cause the electronic device 505 to perform at least the following share content 525 with a first contact based at least in part on a configuration of a second contact. In an example embodiment, the content 525 is at least one of the following: a mobile number, a name, a short message service contact, a multimedia messaging service contact, an email address, a chat identifier, a location, an Internet protocol address, an Inter service provider, a voice over Internet protocol client, user profile information, one or more shared files, or combination thereof.

In an embodiment, the processor 510 may be configured to send an invitation acceptance from a second contact. For example, the processor 510 sends a confirmation to share content with the second contact.

In an example embodiment, the processor 510 is further configured to send a privacy configuration from the second contact. For example, the processor 510 sends a request to not share contact information. In an example embodiment, the processor 510 is further configured to send an invitation acceptance and set a privacy configuration concurrently. For example, the processor 510 sends an invitation acceptance to receive shared content, but sends a privacy configuration indicating not to include the user contact information. In an example embodiment, the processor 510 is further configured to receive an update of what content to share with the second contact. For example, the processor receives a list of content information to be shared.

In an example embodiment, the user interface 520 is configured to display the content 525 to the first contact. For example, a user views the shared content on a display. A technical effect of one or more of the example embodiments disclosed herein is displaying shared content to a user.

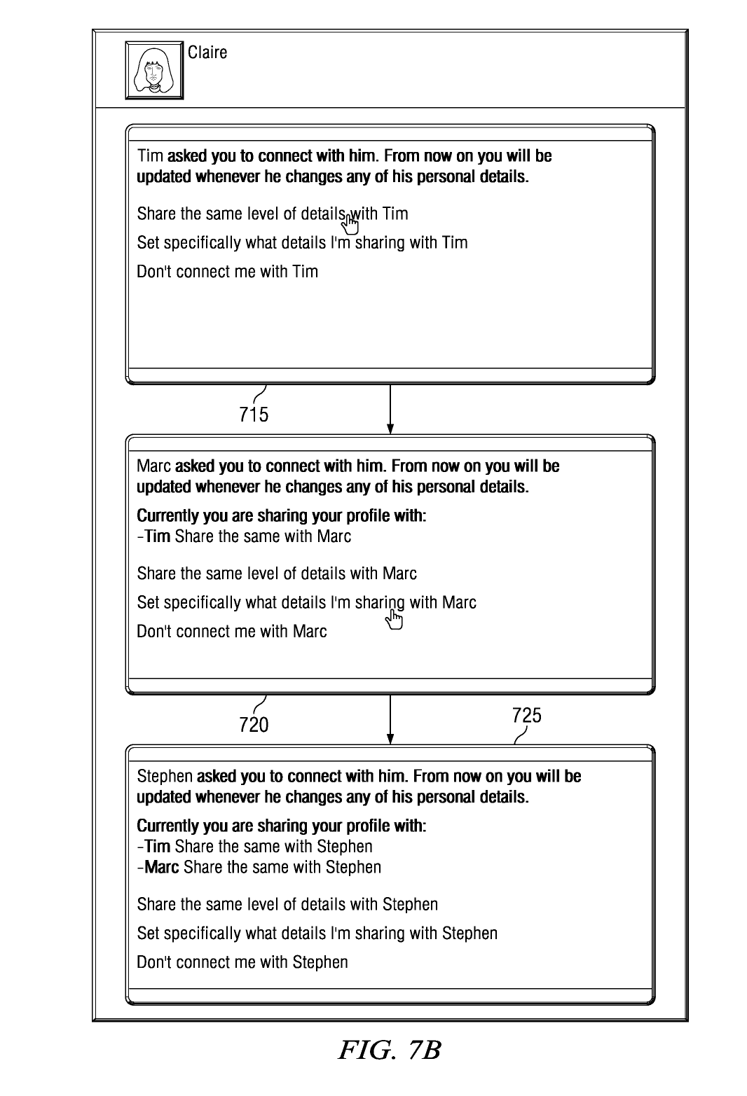

FIG. 6 is a flow diagram illustrating an example method 600 to receive an invitation in accordance with an example embodiment of the invention. Example method 600 may be performed by an electronic device, such as electronic device 505 of FIG. 5.

At 605, an invitation is received. In an example embodiment, a processor of the electronic device receives an invitation from a computer, such as computer 305 of FIG. 3. For example, the processor receives an invitation to share content with the computer.

At 610, it is determined whether to apply the same rule to the contact who is being invited. If at 610 it is determined to apply the same rule to the contact who is being invited, then at 615, the invitation is accepted. The example method 600 ends. If at 610 it is determined not to apply the same rule to the contact who is being invited, then at 620 it is determined whether to use a previous contact.

If at 620 it is determined to use a previous contact for sharing, then at 630 it is determined whether to apply the same rule as the previous contact. In an example embodiment, a processor of the computer, such as processor 310 of FIG. 3 is configured to allow section of a rule relating to a share configuration. For example, the processor allows a user to select a rule for a contact to associate with another contact.

If at 630 it is determined to apply the same rule as the previous contact, then at 635 the previous contact rule is used. In an example embodiment, the processor is configured to receive an acceptance of the previous rule. For example, the user accepts the rule and the processor receives the acceptance. At 615, the invitation is accepted. The example method 600 ends.

If at 630 it is determined not to apply the same rule as the previous contact, then the example method 600 continues at 625. At 625, rules for the contact are set. In an example embodiment, the user interface is configured to allow a user to select the rules. For example, the user selects the contact to be associated with another contact. The example method 600 continues at 615.

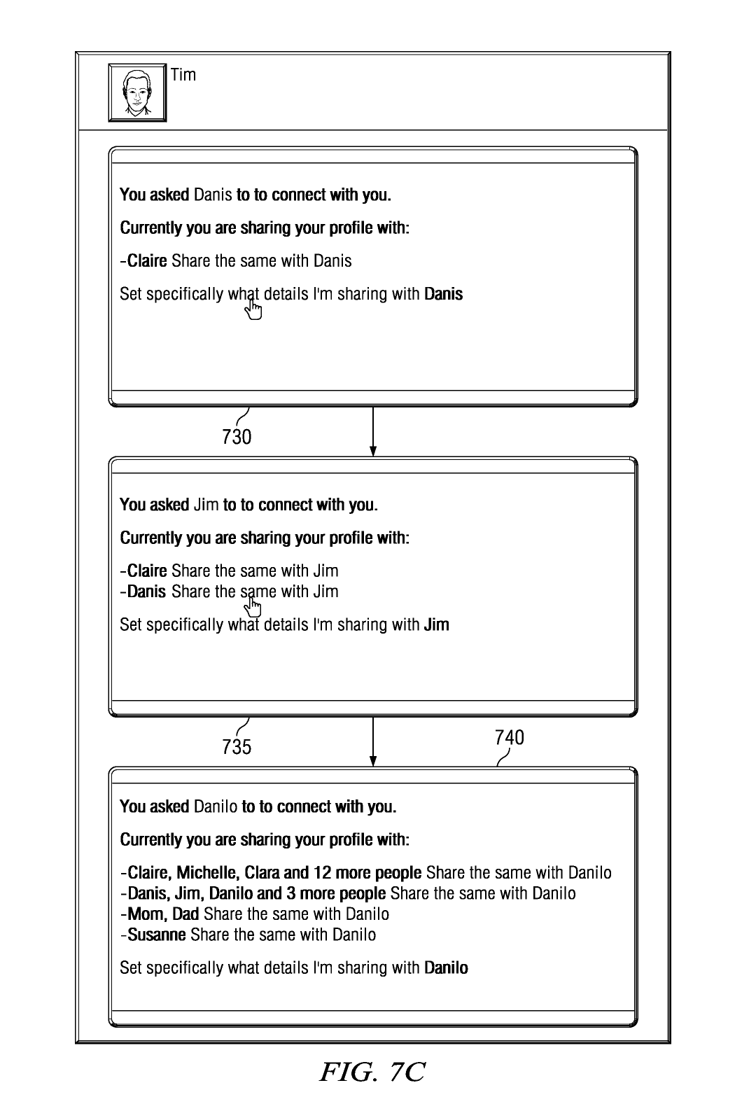

FIG. 7A is a screen view depicting a computer operating in accordance with an example embodiment. In this example embodiment, a user interface, such as user interface 520 of FIG. 5, is configured to display a sent invitation 705 and/or an invitation acceptance 710. It should be understood that the sent invitation 705 depicts a configuration view, such as the sent invitation at 415 of FIG. 4, to share content. The invitation acceptance 710 depicts the received confirmation of acceptance to sharing content.

FIG. 7B is a screen view depicting an electronic device operating in accordance with an example embodiment. In this example embodiment, a user interface, such as user interface 520 of FIG. 5, is configured to display multiple received invitations 715, 720, 725 for sharing content. In particular, received invitation 715 depicts an invitation to share content with Tim, received invitation 720 depicts an invitation to share content with Marc, and received invitation 725 depicts an invitation to share content with Stephen. In such a case, the user may accept one or more of the received invitations 715, 720, 725 to share contact with the user whom sent the invitation. It should be understood that each of these received invitations 715, 720, 725 may be displayed together or separately.

FIG. 7C is a screen view depicting a configuration view on an electronic device operating in accordance with an example embodiment. In this example embodiment, a user interface, such as user interface 520 of FIG. 5, is configured to display multiple received invitations 730, 735, and a confirmation screen 740 for sharing content. In particular, received invitation 730 depicts an invitation to share content with Danis, received invitation 735 depicts an invitation to share content with Jim, and confirmation screen 740 depicts each of the shared content with each of the contacts. It should be understood that each of these received invitations 730, 735 and the confirmation screen may be displayed together or separately.

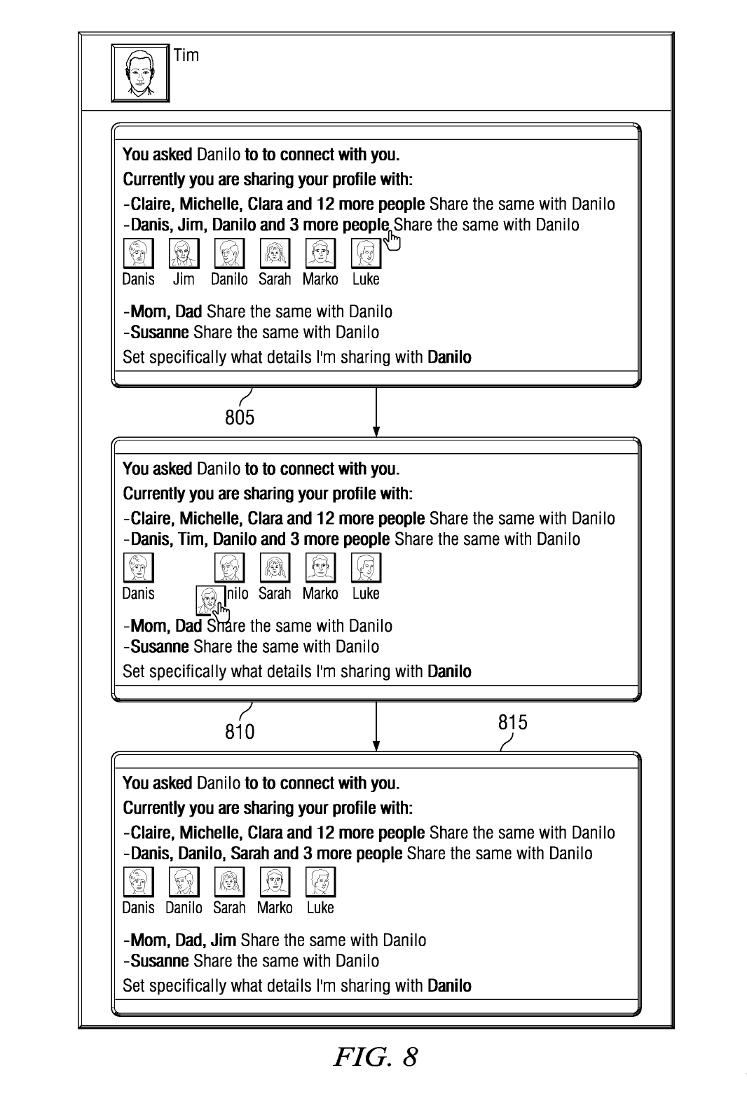

FIG. 8 is a screen view depicting a drag and drop feature on a computer operating in accordance with an example embodiment. In an example embodiment, a user interface, such as user interface 520 of FIG. 5, is configured to display received invitations views 805, 810, 815. Further, the user interface allows a drag and drop feature to allow a user to drag another contact into or out from the share configuration. By dragging and dropping contacts, a user can add or remove users in which contact is shared. It should be understood that the sharing of content may be achieved by employing example embodiments. A technical effect of one or more of the example embodiments disclosed herein is dragging and dropping contacts to share content the same as another contact.

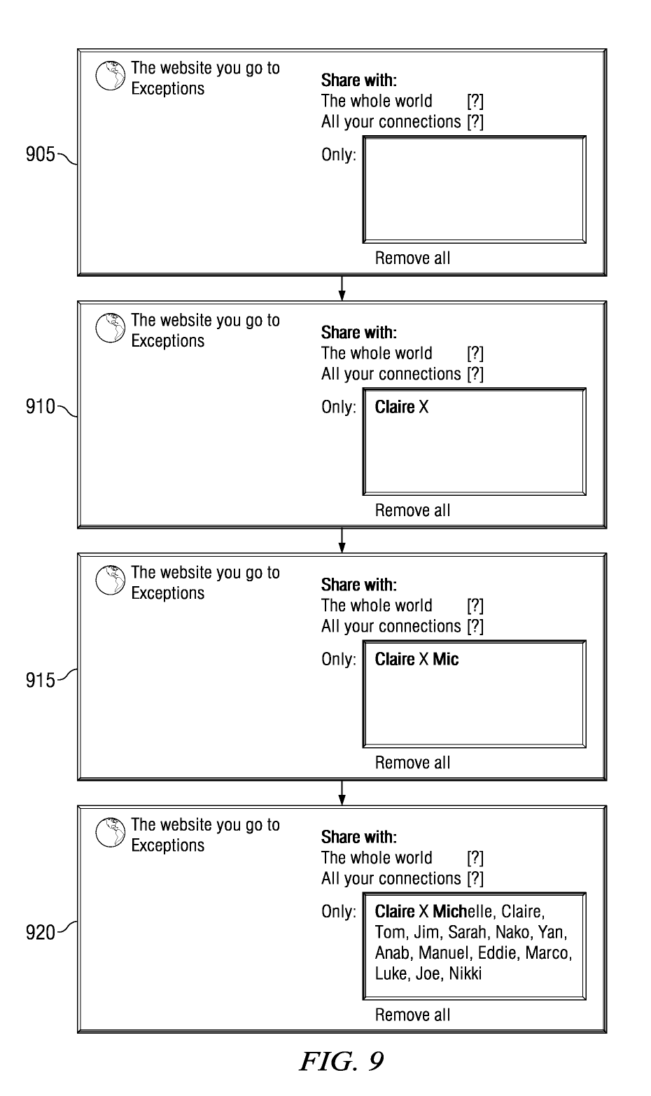

FIG. 9 is a screen view depicting another configuration view on a computer operating in accordance with an example embodiment. In an example embodiment, configuration views 905, 910, 915, 920 facilitate a user to configure sharing among one or more contacts. In particular, the user may select to exclude a user, such as the user in configuration view 910, from a website. In an embodiment, the exclusion may be configured by user choice, a parental control, and/or the like.

Without in any way limiting the scope, interpretation, or application of the claims appearing below, a technical effect of one or more of the example embodiments disclosed herein may be sharing different content based at least in part on the contact. Another technical effect of one or more of the example embodiments disclosed herein may be displaying shared content to a user. Another technical effect of one or more of the example embodiments disclosed herein may be dragging and dropping contacts to share content the same as another contact.

Embodiments of the present invention may be implemented in software, hardware, application logic or a combination of software, hardware and application logic. The software, application logic and/or hardware may reside on an electronic device, a computer, or a service. If desired, part of the software, application logic and/or hardware may reside on an electronic device, part of the software, application logic and/or hardware may reside on a computer, and part of the software, application logic and/or hardware may reside on a service. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
at least one processor and at least one memory including computer program code, the at least one memory and the computer program code configured to, with the at least one processor, cause the apparatus to perform at least the following:
receive content related to a first contact based at least in part on a configuration of a second contact; and
a user interface configured to:
display the content.

2. The apparatus of claim 1 wherein the content is at least one of the following: a mobile number, a name, a short message service contact, a multimedia messaging service contact, an email address, a chat identifier, a location, an Internet protocol address, an Inter service provider, a voice over Internet protocol client, user profile information, one or more shared files, or combination thereof.

3. The apparatus of claim 1 further comprising a third contact having shared content different than the shared content of the second contact.

4. The apparatus of claim 1 wherein the processor is further configured to receive an invitation to the second contact.

5. The apparatus of claim 1 wherein the processor is further configured to receive an invitation acceptance from the second contact.

6. The apparatus of claim 1 wherein the processor is further configured to receive a privacy configuration from the second contact.

7. The apparatus of claim 1 wherein the processor is further configured to receive an invitation acceptance and set a privacy configuration concurrently.

8. The apparatus of claim 1 wherein the user interface is further configured to display a content sharing menu with the second contact.

9. The apparatus of claim 8 wherein the processor is further configured to receive an update of what content to share with the second contact.

10. The apparatus of claim 9 wherein the user interface is further configured to display the updated content to the second contact.

11. A method, comprising:
receiving content related to a first contact based at least in part on a configuration of a second contact; and
displaying the content.

12. The method of claim 11 wherein the content is at least one of the following: a mobile number, a name, a short message service contact, a multimedia messaging service contact, an email address, a chat identifier, a location, an Internet protocol address, an Inter service provider, a voice over Internet protocol client, user profile information, one or more shared files, or combination thereof.

13. The method of claim 11 further comprises shared content with a third contact where the shared content is different than the shared content of the second contact.

14. The method of claim 11 further comprises receiving an invitation to the second contact.

15. The method of claim 11 further comprises receiving an invitation acceptance from the second contact.

16. The method of claim 11 further comprises receiving a privacy configuration from the second contact.

17. The method of claim 11 further comprises receiving an invitation acceptance and set a privacy configuration concurrently.

18. The method of claim 11 further comprises displaying a content sharing menu with the second contact.

19. The method of claim 18 further comprises receiving an update of what content to share with the second contact.

20. A computer program product comprising a computer-readable medium bearing computer program code embodied therein for use with a computer, the computer program code comprising:
code for receiving content related to a first contact based at least in part on a configuration of a second contact; and
code for displaying the content to the first contact.

21-54. (canceled)
